(19) United States
(12) Patent Application Publication
(10) Pub. No.: US 2026/0027679 A1
(43) Pub. Date: Jan. 29, 2026

(54) REMOTE OPERATION PLIERS

(71) Applicant: NAGAKI SEIKI CO., LTD., Osaka (JP)

(72) Inventors: Takayuki NAGAKI, Nara (JP); Tamotsu IWAMA, Osaka (JP)

(73) Assignee: NAGAKI SEIKI CO., LTD., Osaka (JP)

(21) Appl. No.: 19/121,631

(22) PCT Filed: Sep. 22, 2023
(86) PCT No.: PCT/JP2023/034502

§ 371 Date: Apr. 16, 2025

(30) Foreign Application Priority Data
Oct. 18, 2022 (JP) 2022-166682

(51) Int. Cl. B25B 7/08; B25B 7/04; B25G 1/04

(52) U.S. Cl. CPC B25B 7/08; B25B 7/04; B25G 1/04

(57) ABSTRACT

Remote operation pliers are configured by pivotally supporting pliers such that the angle thereof can be

changed by a pivot shaft relative to a base provided to the tip of a main operation rod. A fixed-side gripping piece and a movable-side gripping piece of the pliers can open and close about the pivot shaft. The fixed angle of the fixed-side gripping piece can be changed relative to the base by positioning an index plunger. The movable-side gripping piece is capable of opening and closing by a sub operation rod coupled to a coupling end. The sub operation rod has a length adjustment section between a tool-side end and an operator-side end. The length adjustment section has a nested structure of a cylinder part and a core part in order to maintain a movable range of the sub operation rod constant when changing the gripping angle of the pliers.

### TECHNICAL FIELD

The present invention relates to remote operation pliers for use in cable installation work and the like.

### BACKGROUND ART

In cable installation work and the like, remote operation tools with insulated remote operation rods are often used to prevent electric shock. Cable installation work includes various operations, and the remote operation tools to be used also widely vary according to the operation. For example, mounting fixtures for transformers, overhead wire clamps, and the like installed on utility poles and towers are fastened and loosened by remote operations using aerial work platforms or from the ground. In such cases, rotary part locking hooks, screwdriver tools, and the like are attached to the tips of the remote operation rods.

In the foregoing fastening and loosening operations, remote operation pliers, or remote operation rods with pliers attached at their tips, are also used to stabilize work objects. Since remote operation pliers can be used to not only stabilize work objects but move them as well, the usage frequency at construction sites is high.

However, in remote operations, unlike when the operator directly holds and operates the pliers, even a slight change in the gripping angle is not easy to make since large movements are needed at the operator side. In particular, in situations where the work environment is congested, similar to being near utility poles, operation tasks are limited because of the limited work space. For such a reason, remote operation pliers with an adjustable gripping angle have heretofore been contemplated.

FIG. 10 shows a conventional indirect live-line gripping tool 100 with an adjustable gripping angle. Between a fixed gripping piece 101a and a movable gripping piece 101b that constitute the gripping tool 101, the fixed gripping piece 101a is configured to be adjustable in angle relative to an insulated operation rod 102. The indirect live-line gripping tool 100 with an adjustable angle as shown in FIG. 10 is described in Patent Literature 1.

### CITATION LIST

### Patent Literature

PTL 1: Japanese Patent Application Laid-Open No. 2000-102125

### SUMMARY OF INVENTION

### Technical Problem

However, in the case of changing the angle of the fixed gripping piece 101a of the indirect live-line gripping tool 100 configured as shown in FIG. 10, the insulated operation rod 102 is supported with one hand, and a lock pin 103 is operated and unlocked with the other hand. In other words, since both hands are fully occupied with just supporting the entire tool and unlocking, the operation of changing the angle of the fixed gripping piece 101a and locking it again in narrow working environment such as the top of a work platform is difficult.

Moreover, once the angle of the fixed gripping piece 101a is changed, the movable range of an operation rod 104 for operating the movable gripping piece 101b also changes in conjunction. As a result, a significant change in the gripping feel occurs, and such a change is difficult for those other than skilled operators to adapt to. Even if the movable gripping piece 101b is also equipped with an adjustment mechanism, the angle adjustment work is already difficult with only the fixed gripping piece 101a. The additional adjustment operation for the movable gripping piece 101b would make the operation extremely cumbersome.

In view of this problem, it is an object of the present invention to provide remote operation pliers in which the gripping angle can be changed without changing the operational feel and in which the gripping angle can be easily changed by a single operator.

### Solution to Problem

To achieve the foregoing object, remote operation pliers according to the present invention are remote operation pliers configured to remotely operate pliers fixed to a main operation rod from an operator-side end of a sub operation rod, the remote operation pliers including: a base that is disposed at a tip of the main operation rod; a fixed-side gripping piece that is pivotally supported on the base by a pivot shaft and capable of selecting a plurality of fixing angles about the pivot shaft; a movable-side gripping piece that is pivotally supported on the base by the pivot shaft in a manner where the movable-side gripping piece opens and closes with respect to the fixed-side gripping piece, the movable-side gripping piece including a coupling end coupled to a tool-side end of the sub operation rod; and a length adjustment section that is disposed between the tool-side end and the operator-side end of the sub operation rod.

In the remote operation pliers according to the present invention, in addition to the foregoing configuration, the length adjustment section includes: a cylinder part in which a through hole is formed in a radial direction; a core part that is slidably disposed inside the cylinder part and in which a recess capable of positioning with the through hole is formed; a lock pin that is capable of being inserted through the through hole and the recess and locking the core part to the cylinder part; and an annular part that is extended, starting from an outer end of the lock pin that is aligned with a radial direction of the cylinder part, in an annular shape to circumferentially encircle the cylinder part.

The remote operation pliers according to the present invention includes, in addition to the foregoing configuration, a biasing unit between the annular part and the cylinder part, the biasing unit being configured to bias the lock pin so that the lock pin is pressed radially inward with respect to the cylinder part.

In the remote operation pliers according to the present invention, in addition to the foregoing configuration, the biasing unit is a spring member configured to increase a distance between the cylinder part and an opposite portion of the annular part, the opposite portion being opposite to a position where the annular part is linked to the lock pin.

In the remote operation pliers according to the present invention, in addition to the foregoing configuration, an index plunger including a positioning pin at one end and a knob at the other end is disposed on the base, the index plunger being configured so that the positioning pin biased to protrude engages with the fixing-side gripping piece and fixes an angle between the fixed-side gripping piece and the base, and the fixed-side gripping piece includes a plurality of angle adjustment holes formed in a row in a circumferential direction about the pivot shaft, the positioning pin being capable of engaging with the angle adjustment holes.

In the remote operation pliers according to the present invention, in addition to the foregoing configuration, the base includes a lever unit configured to pull out the knob by a first-class lever mechanism.

In the remote operation pliers according to the present invention, in addition to the foregoing configuration, force components in mutually opposite directions are included between an input force direction against the biasing unit and an input force direction of the lever unit.

### Advantageous Effects of Invention

As described above, according to the present invention, the fixed-side gripping piece and the movable-side gripping piece are pivotally supported on the base by the same pivot shaft. The gripping angle of the pliers relative to the main operation rod can thus be changed independent of the opening-closing mechanism. Moreover, the sub operation rod is provided with the length adjustment section, and the movable range of the sub operation rod can be changed depending on a change in the gripping angle. The operational feel can thus be maintained constant even if the gripping angle is changed.

According to the present invention, in addition to the foregoing advantageous effects, the length adjustment section is constituted by the simple nested mechanism including the cylinder part and the core part. This simplicity leads to a reduction in cost. Since the annular part having the lock pin is formed in an annular shape to circumferentially encircle the cylinder part, the lock pin can be operated from any position around the cylinder part. In other words, the lock pin can be unlocked not only by a pulling operation but by a pushing operation as well.

According to the present invention, in addition to the foregoing advantageous effects, the lock pin is biased in a direction of being pushed radially inward (to the recess side). The lock pin can thus be unlocked by pressing the annular part against the cylinder part from the side opposite to where the lock pin is located. Unlike a pulling operation that needs at least two fingers to pinch the member, the pressing operation enables easy unlocking with one finger regardless of the manner of pressing.

According to the present invention, in addition to the foregoing advantageous effects, the spring member is disposed on the opposite portion opposite to the position where the lock pin is linked. The biasing force can thus be efficiently generated. Since the biasing unit can be constituted by the simple structure using a single coil spring, for example, the manufacturing costs can be kept low.

According to the present invention, in addition to the foregoing advantageous effects, the angle of the fixed-side gripping piece subject to relatively large force is fixed by the index plunger of simple configuration. This improves durability compared to complicated angle adjustment mechanisms and the like that use gears and other parts. Moreover, since the intended change angle can be directly selected, the work efficiency improves.

According to the present invention, in addition to the foregoing advantageous effects, the lever unit for pulling out the knob is constituted by a first-class lever. In other words, with the base as the fulcrum and the knob-lifting side as the point of action, the knob can be pulled out to release the fixing of the fixed-side gripping piece by pressing the point of effort toward the base. The operation of pinching the knob can thereby be replaced with the operation of pressing the lever unit toward the base. As a result, the fixing of the fixed-side gripping piece can be easily released with at least one finger.

According to the present invention, in addition to the foregoing advantageous effects, the force applied against the biasing unit in unlocking the lock pin and the force applied to the lever unit in releasing the index plunger to change the angle of the fixed-side gripping piece include components in respective opposite directions. The biasing unit and the lever unit can thus be operated in a pinching manner during unlocking for length adjustment and angle change. For example, the two unlocking operations can be simultaneously performed by one hand through a pinching operation between the index finger and the thumb. This configuration improves the work efficiency.

### BRIEF DESCRIPTION OF DRAWINGS

FIG. 1 is an enlarged perspective view of a tool-side end of remote operation pliers according to the present invention.

FIG. 2 is an exploded perspective view of a length adjustment section of a sub operation rod.

FIG. 3 shows a lock mechanism of the length adjustment section. FIG. 3(a) is a diagram showing a locked state, and FIG. 3(b) is a diagram showing an unlocked state.

FIG. 4 is a perspective view showing only the components of pliers.

FIG. 5 is a perspective view showing a base and a lever unit in a disassembled state.

FIG. 6 shows sectional views illustrating operations of the lever unit.

FIG. 7 shows two modes of plier fixing angles. FIG. 7(a) is a diagram showing an arrangement where a gripping position falls on the extending direction of a main operation rod, and FIG. 7(b) is a diagram showing a state of deepest bending relative to the extending direction of the main operation rod.

FIG. 8 is a plan view for describing unlocking of a fixed-side gripping piece and the sub operation rod.

FIG. 9 is a plan view for describing unlocking in a modification of the length adjustment section of the sub operation rod.

FIG. 10 is a diagram showing a conventional indirect live-line gripping tool with an adjustable gripping angle.

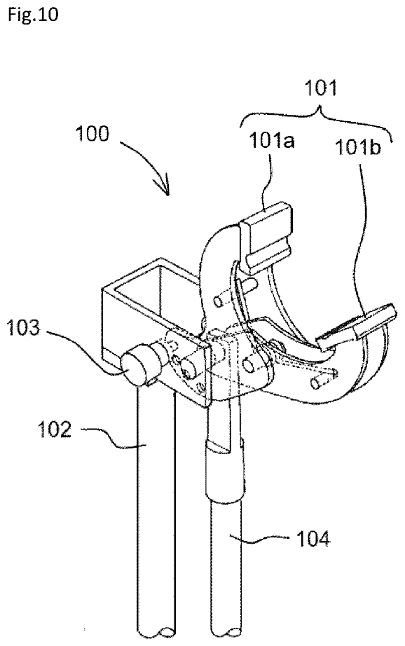

### DESCRIPTION OF EMBODIMENTS

Remote operation pliers according to an embodiment of the present invention will be described below with reference to the drawing.

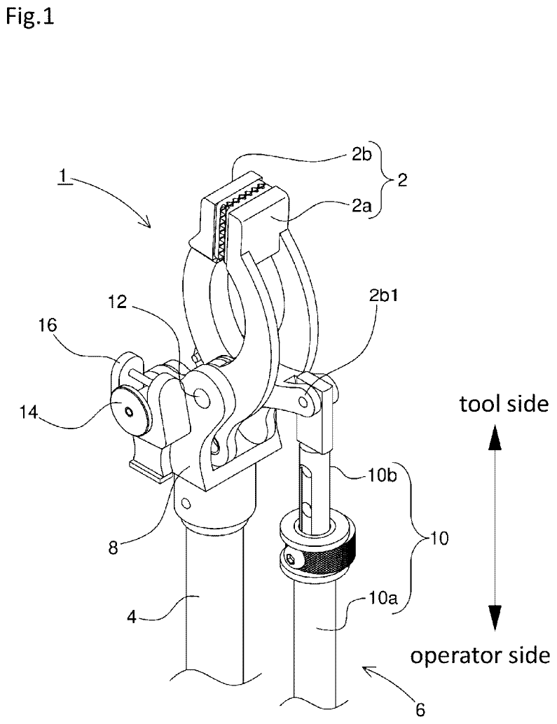

FIG. 1 is an enlarged perspective view of a tool-side end of remote operation pliers 1 according to the present invention.

The remote operation pliers 1 according to the present embodiment include pliers 2 attached to a base 8 disposed at the tool-side tip of a main operation rod 4. A fixed-side gripping piece 2a, a component of the pliers 2, is pivotally supported on the base 8 by a pivot shaft 12. This fixed-side gripping piece 2a is fixed to the base 8 so that its angle can be changed. A movable-side gripping piece 2b, the other component of the pliers 2, is pivotally supported by the pivot shaft 12 in a manner where the movable-side grippng piece 2b is capable of opening and closing with respect to the fixed-side gripping piece 2a. In other words, the pliers 2 are pivotally supported on the base 8 by the pivot shaft 12 so that their angle can be changed, and the pliers 2 are configured to open and close about the same pivot shaft 12.

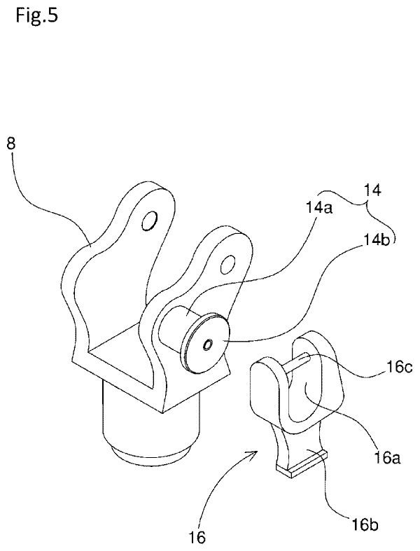

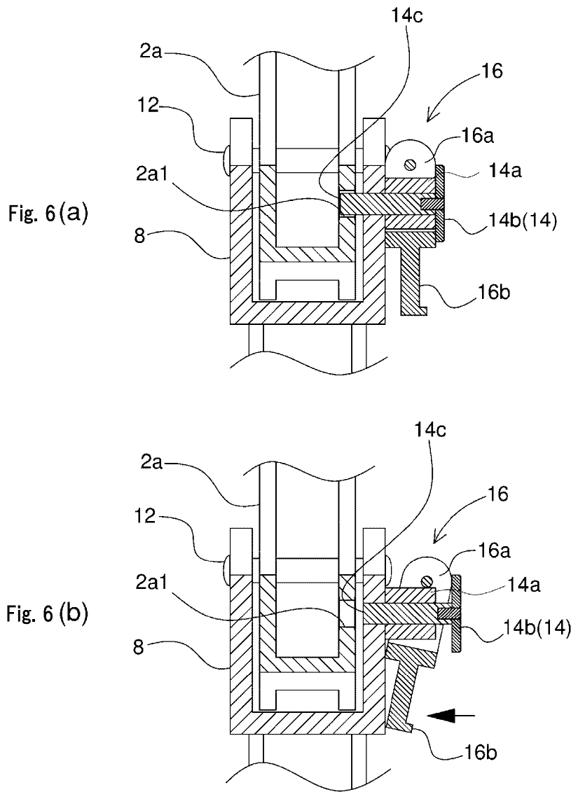

An index plunger 14 is disposed on a side surface of the base 8. This index plunger 14 fixes the fixed-side gripping piece 2a at a selected angle about the pivot shaft 12. A lever unit 16 is provided to operate the index plunger 14. This lever unit 16 will be described below with reference to FIGS. 5 and 6.

A tool-side end of a sub operation rod 6 for operating the pliers 2 to open and close is coupled to a coupling end 2b1 of the movable-side gripping piece 2b. The sub operation rod 6 includes a length adjustment section 10 between its tool-side end and operator-side end. The movable range of the sub operation rod 6 can be maintained constant by adjusting the length of the length adjustment section 10 according to a change in the angle of the pliers 2. With such a configuration, the gripping angle of the pliers 2 can be changed without changing the operational feel of the sub operation rod 6.

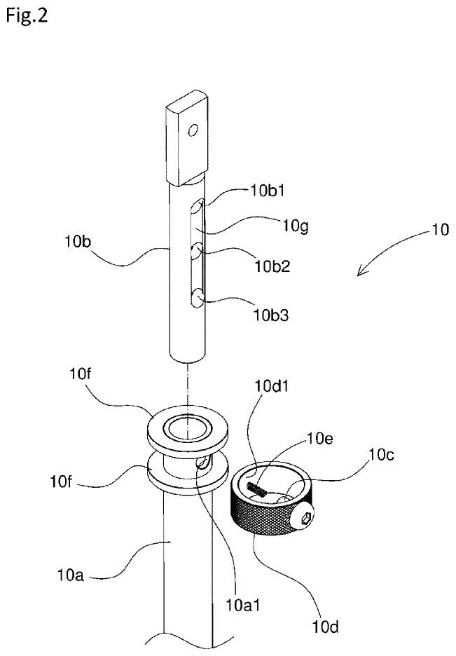

FIG. 2 is an exploded perspective view of the length adjustment section 10 of the sub operation rod 6.

The length adjustment section 10 of the sub operation rod 6 has a nested structure including a cylinder part 10a and a core part 10b. The cylinder part 10a has a longitudinal cavity in which the core part 10b can slide. The cylinder part 10a also has a through hole 10a1 that opens in a radial direction. Two flange portions 10f are formed to vertically sandwich the position where this through hole 10a1 is formed.

The core part 10b has three recesses 10b1, 10b2, and 10b3 formed in a row in its longitudinal direction and arranged within a range in which the recesses are capable of positioning with the through hole 10a1 via sliding of the core part 10a. These recesses 10b1, 10b2, and 10b3 are formed inside a guide groove 10g that is longitudinally formed.

The length adjustment section 10 is configured so that one of the recesses 10b1, 10b2, and 10b3 can be positioned to the through hole 10a1 and the positioned state can be fixed by engaging a lock pin 10c. An outer end of the lock pin 10c is fixed to an annular part 10d. This annular part 10d is formed with dimensions that allow for sliding in the extending direction of the lock pin 10c, between the foregoing two flange portions 10f. With the lock pin 10c located in the through hole 10a1 (see FIG. 1), the annular part 10d is located to circumferentially encircle the cylinder part 10a. A coil spring 10e is protruded radially inward from an opposite portion 10d1 of the inner wall of the annular part 10d opposite to the side where the lock pin 10c is fixed, so that the coil spring 10e matches the extending direction of the lock pin 10c. This coil spring 10e is disposed to exert biasing in a direction of increasing the distance between the cylinder part 10a and the annular part 10d.

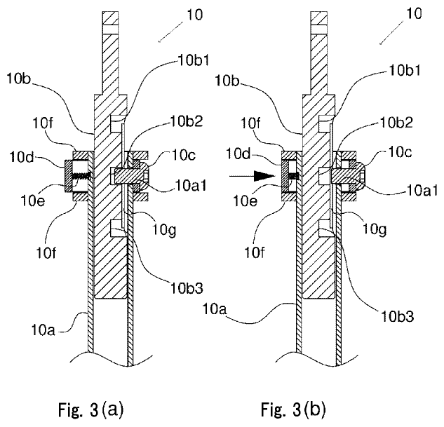

FIG. 3 shows a lock mechanism of the length adjustment section 10. FIG. 3(a) shows a locked state, and

FIG. 3(b) shows an unlocked state. Without external force applied, the coil spring 10e exerts biasing to increase the distance between the cylinder part 10a and the annular part 10d as described above. This effect stabilizes the engaged state where the lock pin 10c is drawn radially inward. Here, the lock pin 10c is shown to be engaged with the recess 10b2 at the middle position among the three recesses 10b1, 10b2, and 10b3. The annular part 10d is formed with a height dimension substantially the same as the distance between the two flange portions 10f, and no rattling occurs. The annular part 10d can thus slide smoothly in the radiation direction of the cylinder part 10a with the two flange portions 10f as guides.

FIG. 3(b) shows a state where external force is applied in a direction of compressing the coil spring 10e. When the annular part 10d is pressed to compress the coil spring 10e, the lock pin 10c integrally fixed to the annular part 10d moves radially outward and is disengaged from the recess 10b2. In other words, the core part 10b is unlocked from the cylinder part 10a.

As described above, since the annular part 10d can slide with the two flange portions 10f as guides, the unlocking operation is smoothly performed. This configuration enables easy unlocking operation with one finger, for example. Since the unlocking can be performed not only by compressing the coil spring 10e with a finger but also by pressing something other than a finger against the annular part 10d, the operation can be easily performed even in situations where there are not enough hands available.

The configuration according to the present embodiment is designed so that the radially inner tip of the lock pin 10c remains within the guide groove 10g of the core part 10b even when a force is applied to the coil spring 10e to its compression limit. Since the tip of the lock pin 10c moves along the guide groove 10g even in the unlocked state, twisting of the core part 10b relative to the cylinder part 10a can be prevented.

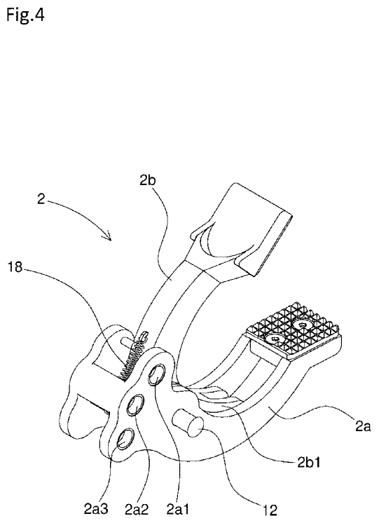

FIG. 4 is a perspective view showing only the components of the pliers 2.

The fixed-side gripping piece 2a has three angle adjustment holes 2a1, 2a2, and 2a3 formed on the side surface on which the lever unit 16 is provided among the side surface that makes sliding contact with the base 8 (see FIG. 1). These angle adjustment holes 2a1, 2a2, and 2a3 are formed in a row in a circumferential direction about the pivot shaft 12. The movable-side gripping piece 2b pivotally supported by the pivot shaft 12 is linked with the fixed-side gripping piece 2a by a coil spring 18. This coil spring 18 is provided to bias the movable-side gripping piece 2b in an open direction relative to the fixed-side gripping piece 2a. The provision of this coil spring 18 allows for attention to be focused solely on the relationship between the fixed-side gripping piece 2a and the base 8 when changing the angle of the pliers 2, and therefore the complexity of the operation is reduced. When the length adjustment section 10 (see FIG. 1) is unlocked, the coupling end 2b1 of the movable-side gripping piece 2b is lifted up by the biasing of the coil spring 18. In other words, the coupling end 2b1 is fixed. This configuration allows for attention to be focused solely on the positional relationship of the cylinder part 10a (see FIG. 1) with the core part 10b during the length adjustment, and therefore the operation becomes easier to perform. In such a manner, the provision of the coil spring 18 for biasing the movable-side gripping piece 2b in the open direction relative to the fixed-side gripping piece 2a improves the work efficiency of reconfiguration such as changing the angle of the tool with many movable parts.

FIG. 5 is a perspective view showing the base 8 and the lever unit 16 disassembled.

The index plunger 14 is disposed on the side surface of the base 8. Although not shown in FIG. 5, a positioning pin of this index plunger 14 is disposed to be projectable toward and retractable from the inside of the base 8 (to be described below with reference to FIG. 6). The positioning pin is biased in a direction of projecting toward the inside of the base 8, and configured to be retracted into a main body portion 14a when a knob 14b is pulled against the biasing.

The lever unit 16 is disposed so that the main body portion 14a of the index plunger 14 is accommodated in its U-shaped accommodation portion 16a. A stop pin 16c for preventing detachment from the main body portion 14a of the index plunger 14 is disposed on the opening side of the U-shape of the accommodation portion 16a. The inner diameter of the accommodation portion 16a is set to be smaller than the dimension of the knob 14b of the index plunger 14. This configuration enables operation with the knob 14b hooked on the inner rim of the accommodation portion 16a. Next, the index plunger 14 by this lever unit 16 will be described with reference to FIG. 6.

FIG. 6 shows sectional views illustrating operation of the lever unit 16. For the convenience of description, the pliers 2 are shown here with only the fixed-side gripping piece 2a, and the movable-side gripping piece 2b is omitted in the diagram. FIG. 6(a) shows a state where the fixed-side gripping piece 2a is locked. FIG. 6(b) shows a state where the fixed-side gripping piece 2b is unlocked.

As can be seen in FIG. 6(a), the accommodation portion 16a of the lever unit 16 is pressed against the base 8 by the knob 14b biased toward the main body portion 14a of the index plunger 14. Although not having a structure directly coupled to the base 8, the lever unit 16 is thus stably held using the biasing of the knob 14b. The omission of the structure for coupling the lever unit 16 to the base 8 enables a reduction in weight, and can reduce operation load and lower manufacturing costs.

FIG. 6(b) shows a state where lever operation force is applied to an input portion 16b of the lever unit 16. When the input portion 16b is pressed toward the base 8, the bottom corner of the accommodation portion 16a is pressed against the side surface of the base 8, and a lever action occurs with this pressed corner as the fulcrum. The top end of the accommodation portion 16a acts as the point of action, and pulls out the knob 14b while being in slide contact with the back side of the knob 14b. The positioning pin 14c is thereby pulled out of the angle adjustment hole 2a1 of the fixing-side gripping piece 2a, and the pliers 2 (fixed-side gripping piece 2a) are unlocked. In such a manner, the operation of pressing the input portion 16b of the lever unit 16 is transformed into the operation of pulling the knob 14b of the index plunger 14 by the action of a first-class lever. This facilitates the unlocking operation as with the forgoing annular part 10d.

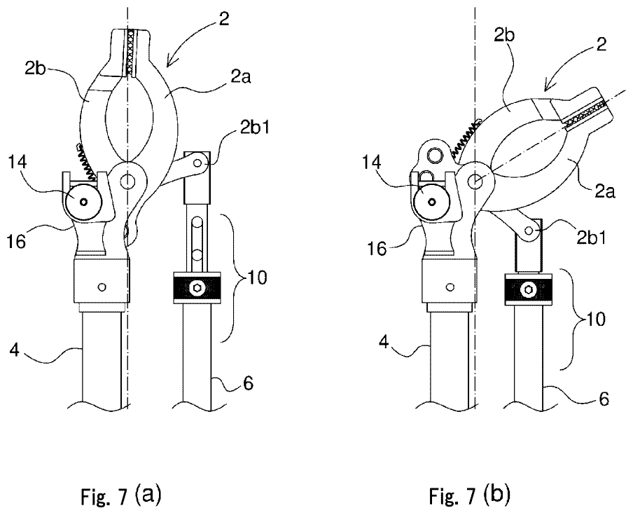

FIG. 7 shows diagrams illustrating two modes of variation in the fixing angle of the pliers 2. FIG. 7(a) shows an arrangement where the holding position falls on the extending direction of the main operation rod 4. FIG. 7(b) shows a state of deepest bending with respect to the extending direction of the main operation rod 4.

As shown in FIG. 7(a), when the gripping position of the pliers 2 is directed in the extending direction of the main operation rod 4, the coupling end 2b1 of the movable-side gripping piece 2b coupled to the sub operation rod 6 lifts up. To compensate for the change in the movable range of the sub operation rod 6 lifted up, an adjustment of the positional relationship of the cylinder part 10a with the core part 10b is made using the length adjustment section 10 of the sub operation rod 6.

In the configuration according to the present embodiment, when the gripping position is directed in the extending direction of the main operation rod 4 as in FIG. 7(a), the core part 10b of the sub operation rod 6 is locked to the cylinder part 10a at the position of the lowest recess 10b3 (see FIG. 2) among the three recesses 10b1, 10b2, and 10b3 formed therein.

As shown in FIG. 7(b), when the fixed-side gripping piece 2a is fixed at the angle adjustment hole 2a3 of the deepest bending by the index plunger 14 among the angle adjustment holes 2a1, 2a2, and 2a3 formed therein (see FIG. 4), the annular part of the sub operation rod 6 is locked to the cylinder part 10a at the topmost recess 10b1 (see FIG. 2) among the three recesses 10b1, 10b2, and 10b3 of the core part 10b. Constant operational feel can thereby be maintained both in the state of FIG. 7(a) and in the state of FIG. 7(b) without changing the arrangement of the components below the cylinder part 10a of the sub operation rod 6.

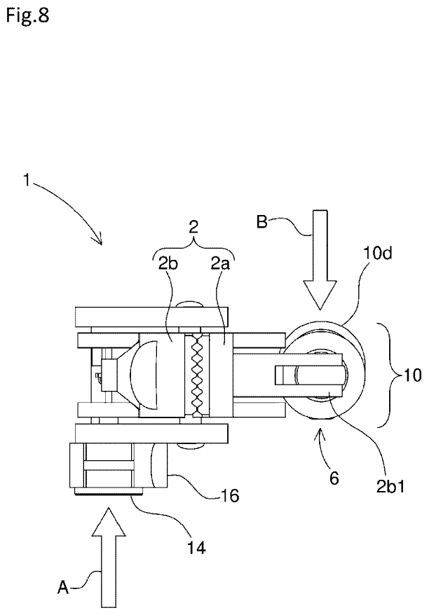

FIG. 8 is a plan view for describing the unlocking operations of the fixed-side gripping piece 2a and the sub operation rod 6.

An arrow A indicates the direction in which an unlocking input is given to the lever unit 16 for unlocking the index plunger 14 fixing the gripping angle of the fixed-side grip piece 2a. An arrow B indicates the direction in which an unlocking input is given to the length adjustment section 10 of the sub operation rod 6.

As can be seen from FIG. 8, the directions of these arrows A and B are opposite to each other. For example, in the case of left-handed operation, the forces can thus be simultaneously applied in the unlocking directions by pressing the lever unit 16 with the root of the thumb and pressing the annular part 10d with the tip of the index finger. Here, using the free right hand, the pliers 2 (fixed-side gripping piece 2a) can be moved to the intended change position, and the position of cylinder part 10a of the sub operation rod 6 can be adjusted to the core part 10b (see FIG. 1).

With the conventional configuration where the index unlocking operations at the two points are unable to be simultaneously performed with one hand.

By contrast, with the configuration according to the present embodiment, the index plunger 14 of the fixed-side gripping piece 2a and the length adjustment section 10 of the sub operation rod 6 both can be unlocked by a pressing operation. In addition, since the pressing directions for unlocking are configured to be opposite to each other, the unlocking operations can be simultaneously performed by applying force in a pinching manner. The two locks can thus be unlocked with one hand while positioning is performed with the other hand, with a significant improvement in work efficiency.

Since the annular part 10d is configured to be vertically sandwiched between the two flange portions 10f, the cylinder part 10a can be positioned to the core part 10b with fingers on the flange portions 10f to keep applying force in the unlocking direction of the lock pin 10c.

According to the configuration of the present embodiment, the sub operation rod 6 is provided with the length adjustment mechanism, and the coupling end 2b1 of the movable-side gripping piece 2b can be located away from the main operation rod 4. This enables the pivot shaft 12 serving as the opening and closing center of the movable-side gripping piece 2b to be designed closer to the extension of the main operation rod 4. As a result, when force is applied to the pliers 2 from the sub operation rod 6, the reaction force from the pliers 2 can be received at a position close to the extension of the main operation rod 4. The deflection of the main operation rod 4 can thereby be minimized.

### Modification

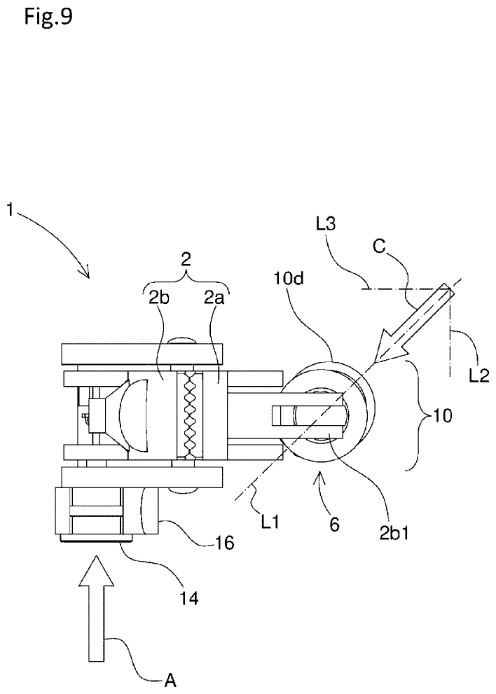

FIG. 9 is a plan view for describing an unlocking operation in a modification of the length adjustment section 10 of the sub operation rod 6. Configurations other than the sub operation rod 6 are the same as those shown in FIG. 8.

In the configuration of FIG. 9, the lock pin 10c is located along the direction of an imaginary line L1 (see FIGS. 1 and 2). The coil spring 10e is therefore also located along this imaginary line L1. An arrow C indicates the direction in which the input for unlocking the length adjustment section 10 is given. With such a configuration, the length adjustment section 10 of the sub operation rod 6 needs to be unlocked by applying compression force to the coil spring 10e in the directions of the arrows A and C.

Unlike FIG. 8, the directions of these arrows A and C are not completely opposite to each other. However, with reference to the direction of the arrow A indicating the input to the lever unit 16 on the index plunger 14 side, it can be seen that force on the arrow C side includes a force component along an imaginary line L2 opposite to the arrow A. Even with the configuration like the modification in FIG. 9, the unlocking operations at the two points can thus be simultaneously performed by applying force in a pinching manner as in FIG. 8.

Configuring the relationship of the input directions for unlocking the two points, the lever unit 16 and the length adjustment section 10, so that at least mutually opposite components are included as described above enables simultaneous operations in a pinching manner. This increases the degree of freedom in designing the unlocking directions depending on factors such as the size of the tool and the size of the operator's hand.

The configuration of the above-described embodiment is an example of the present invention, and further includes the following modifications.
(1) In the above-described embodiment, the length adjustment section 10 is configured by the nested structure including the cylinder part 10a and the core part 10b. The configuration in which the length adjustment section 10 is adjusted by engaging the lock pin 10c to the through hole 10a1 and the recess 10b1, 10b2, or 10b3 positioned is shown as an example. However, as long as the configuration is provided between the tool-side end and the operator-side end of the sub operation rod 6, any configuration like locking by a clamp structure may be acceptable.
(2) In the above-described embodiment, the length adjustment section 10 is provided at the tool-side end in the vicinity of the movable-side gripping piece 2b as an example. However, the length adjustment section 10 may be provided at the intermediate portion or the operator-side end of the sub operation rod 6.
(3) In the above-described embodiment, a screw member is adopted as an example for the lock pin 10c, and the lock pin 10c and the annular part 10d are integrally formed by fastening the screw member from the outer side of the annular part 10d. However, the annular part and the lock pin may be integrally shaped.
(4) In the above-described embodiment, the configuration is shown in which the coil spring 10e is adopted as an example for the biasing unit for increasing the distance between the annular part 10d and the cylinder part 10a has been described. However, a biasing unit other than the coil spring may be used as long as the biasing direction is the same. In addition, as long as the lock pin 10c is configured to be applied with force by biasing in the longitudinal direction, a biasing unit may not be provided at the opposite position to the lock pin 10c.
(5) In the above-described embodiment, the configuration in which the core part 10b of the length adjustment section 10 is coupled to the coupling end 2b1 of the movable-side gripping piece 2b is shown as an example. However, the cylinder part 10a side may be configured to be able to be coupled to the coupling end 2b1, and the core part 10b may be disposed on the operator side.
(6) In the above-described embodiment, the

configuration in which the lever unit 16 is fixed by being pressed against the base 8 by utilizing the biased knob 14b of the index plunger 14 is shown as an example. However, a configuration in which the lever unit 16 is directly coupled to the base 8 via a hinge structure or the like may be adopted.

### INDUSTRIAL APPLICABILITY

The remote operation pliers of the present invention is useful not only in cable installation work but also in high-place work.

### REFERENCE SIGNS LIST

1 remote operation pliers
2 pliers
2a fixed-side gripping piece
2a1, 2a2, 2a3 angle adjustment hole
2b movable-side gripping piece
2b1 coupling end
4 operation rod
6 sub operation rod
8 base
10 length adjustment section
10a cylinder part
10a1 through hole
10b core part
10b1, 10b2, 10b3 recess
10c lock pin
10d annular part
10e coil spring (biasing unit)
10f flange portion
10g guide groove
12 pivot shaft
14 index plunger
14a main body portion
14b knob
14c positioning pin
16 lever unit
16a accommodation portion
16b input portion
16c stop pin
18 coil spring
A, B, C arrow
L1, L2, L3 imaginary lire

1. Remote operation pliers configured to remotely operate pliers fixed to a main operation rod from an operator-side end of a sub operation rod, the remote operation pliers comprising:
a base that is disposed at a tip of the main operation rod;
a fixed-side gripping piece that is pivotally supported on the base by a pivot shaft and capable of selecting a plurality of fixing angles about the pivot shaft;
a movable-side gripping piece that is pivotally supported on the base by the pivot shaft in a manner where the movable-side gripping piece opens and closes with respect to the fixed-side gripping piece, the movable-side gripping piece including a coupling end coupled to a tool-side end of the sub operation rod; and
a length adjustment section that is disposed between the tool-side end and the operator-side end of the sub operation rod.

2. The remote operation pliers according to claim 1, wherein
the length adjustment section includes:
a cylinder part in which a through hole is formed in a radial direction;
a core part that is slidably disposed inside the cylinder part and in which a recess capable of positioning with the through hole is formed;
a lock pin that is capable of being inserted through the through hole and the recess and locking the core part to the cylinder part; and
an annular part that is extended, starting from an outer end of the lock pin that is aligned with a radial direction of the cylinder part, in an annular shape to circumferentially encircle the cylinder part.

3. The remote operation pliers according to claim 2, comprising a biasing unit between the annular part and the cylinder part, the biasing unit being configured to bias the lock pin so that the lock pin is pressed radially inward with respect to the cylinder part.

4. The remote operation pliers according to claim 3, wherein the biasing unit is a spring member configured to increase a distance between the cylinder part and an opposite portion of the annular part, the opposite portion being opposite to a position where the annular part is linked to the lock pin.

5. The remote operation pliers according to claim 4, wherein:
an index plunger including a positioning pin at one end and a knob at the other end is disposed on the base, the index plunger being configured so that the positioning pin biased to protrude engages with the fixing-side gripping piece and fixes an angle between the fixed-side gripping piece and the base; and
the fixed-side gripping piece includes a plurality of angle adjustment holes formed in a row in a circumferential direction about the pivot shaft, the positioning pin being capable of engaging with the angle adjustment holes.

6. The remote operation pliers according to claim 5, wherein the base includes a lever unit configured to pull out the knob by a first-class lever mechanism.

7. The remote operation pliers according to claim 6, wherein force components in mutually opposite directions are included between an input force direction against the biasing unit and an input force direction of the lever unit.
